(19) United States
(12) Patent Application Publication
(10) Pub. No.: US 2026/0237987 A1
(43) Pub. Date: Aug. 13, 2026

(54) WALL BOX-MOUNTED OCCUPANCY SENSOR WITH DOME-SHAPED SENSOR LENS

(71) Applicant: EATON INTELLIGENT POWER LIMITED, DUBLIN 4 (IE)

(72) Inventors: Jing Su, Shanghai (CN); Paley Li, Shanghai (CN); Eduardo Jose Ferreira Dodge, Pittsburgh, PA (US); Hoon Lee, Sugar Hill, GA (US); Justin Franke, Sharpsburg, GA (US); Vinay Vikas Mane, Islampur (IN)

(73) Assignee: EATON INTELLIGENT POWER LIMITED, DUBLIN 4 (IE)

(21) Appl. No.: 19/051,440

(22) Filed: Feb. 12, 2025

(51) Int. Cl. H02G 3/08

(52) U.S. Cl. CPC H02G 3/081

(57) ABSTRACT

A dome-shaped occupancy sensor lens for a front cover of a wall box-mounted electrical wiring device is disclosed. The front cover includes a planar faceplate and the sensor lens. The sensor lens extends outward from the faceplate. The faceplate is planar relative to a length dimension and a width dimension, and the sensor lens extends outward from the faceplate in a depth dimension. The shape of the sensor lens is such that, relative to the plane of the front surface of the faceplate, the profile of the sensor lens is curved in any viewing plane that is orthogonal to the front surface of the faceplate.

### FIELD OF THE INVENTION

The disclosed concept relates generally to electrical wiring devices, and in particular, to occupancy sensors used with electrical wiring devices.

### BACKGROUND OF THE INVENTION

Electrical wiring devices are widely used in residential, commercial, and industrial buildings. Light switches are one well known example of wiring devices. Occupancy sensors are incorporated in electrical wiring devices in order to reduce/minimize power usage, by configuring the devices to only use power when a space is occupied. Occupancy sensors detect movement and can automatically either turn off or reduce the amount of power (i.e. via dimming) used by a wiring device when a space becomes vacant.

Occupancy sensor lenses are typically cylindrical in shape. While occupancy sensors with cylindrical lenses offer the benefits of decreased power usage, cylindrical lenses are also difficult to clean and tend to accumulate debris. This results in a perception of reduced hygiene. Under various environmental and lighting conditions, the geometry of cylindrical lenses leads to abrupt transitions in shape and shadow, which attracts undesirable attention to the electrical wiring devices. Based on research performed in the North American market, most people strongly prefer for electrical wiring devices to have a discrete appearance rather than a prominent appearance.

There is thus room for improvement in occupancy sensors for electrical wiring devices.

### SUMMARY OF THE INVENTION

These needs, and others, are met by a dome-shaped occupancy sensor lens for a front cover of an electrical wiring device.

In accordance with one aspect of the disclosed concept, a front cover for an electrical wiring device includes: a faceplate with a front surface extending in a width dimension and a length dimension, and an occupancy sensor lens extending out from the faceplate in a depth dimension. The occupancy sensor lens is dome-shaped such that, in any plane extending in the depth dimension and orthogonal to the front surface, a profile of the occupancy sensor lens is curved relative to the front surface.

In accordance with another aspect of the disclosed concept, an electrical wiring device comprises: a wall box, a power adjustment circuit contained in the wall box, and a front cover coupled to the wall box. The front cover includes a faceplate with a front surface extending in a width dimension and a length dimension, and an occupancy sensor lens extending out from the faceplate in a depth dimension. The power adjustment circuit and the occupancy sensor lens are in communication with one another, and the power adjustment circuit is configured to adjust the amount of power provided from a power source to a load based on the data obtained by the occupancy sensor lens. The occupancy sensor lens is dome-shaped such that, in any plane extending in the depth dimension and orthogonal to the front surface, a profile of the occupancy sensor lens is curved relative to the front surface.

### BRIEF DESCRIPTION OF THE DRAWINGS

A full understanding of the invention can be gained from the following description of the preferred embodiments when read in conjunction with the accompanying drawings in which:

FIG. 1 shows front views of three different prior art electrical wiring faceplates with cylindrical occupancy sensor lenses;

FIG. 2A is a top plan view of the prior art electrical wiring devices shown in FIG. 1, showing the profile of the cylindrical occupancy sensor lens in the width and depth dimensions relative to the faceplate base;

FIG. 2B is a side elevation view of the prior art electrical wiring devices shown in FIG. 1, showing the profile of the cylindrical occupancy sensor lens in the length and depth dimensions relative to the faceplate base;

FIG. 3 shows a front view of an electrical wiring device having an improved front cover, the front cover having a dome-shaped occupancy sensor lens, in accordance with an exemplary embodiment of the disclosed concept;

FIG. 4A is a top plan view of the disclosed improved electrical wiring device shown in FIG. 3, showing the profile of the dome-shaped occupancy sensor lens in the width and depth dimensions relative to the faceplate base;

FIG. 4B is a side elevation view of the disclosed improved electrical wiring device shown in FIG. 3, showing the profile of the dome-shaped occupancy sensor lens in the length and depth dimensions relative to the faceplate base;

FIG. 5 is a photograph of a front view of the existing wiring devices that are shown in FIG. 1; and

FIG. 6 is a photograph of a front view of the disclosed improved wiring device that is shown in FIG. 3.

### DETAILED DESCRIPTION OF THE INVENTION

Directional phrases used herein, such as, for example, left, right, front, back, top, bottom and derivatives thereof, relate to the orientation of the elements shown in the drawings and are not limiting upon the claims unless expressly recited therein.

As employed herein, the statement that two or more parts or components are “coupled” shall mean that the parts are joined or operate together either directly or indirectly, i.e., through one or more intermediate parts or components, so long as a link occurs. As used herein, “directly coupled” means that two elements are directly in contact with each other. As used herein, “fixedly coupled” or “fixed” means that two components are coupled so as to move as one while maintaining a constant orientation relative to each other.

As employed herein, when ordinal terms such as “first” and “second” are used to modify a noun, such use is simply intended to distinguish one item from another, and is not intended to require a sequential order unless specifically stated.

As employed herein, the term “number” shall mean one or an integer greater than one (i.e., a plurality).

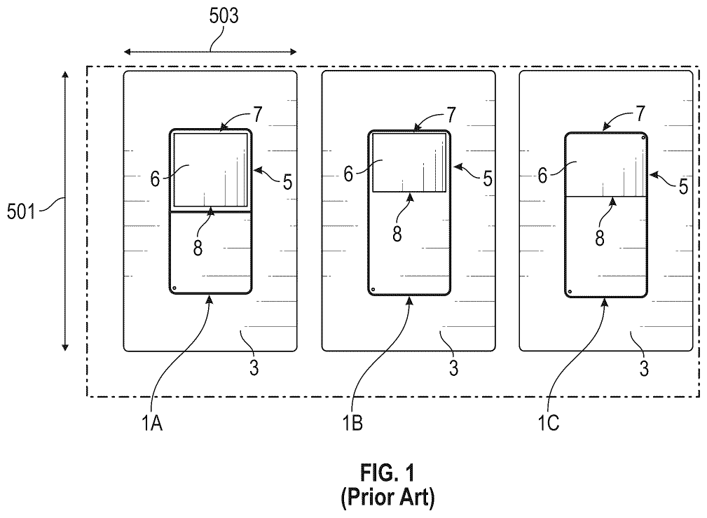

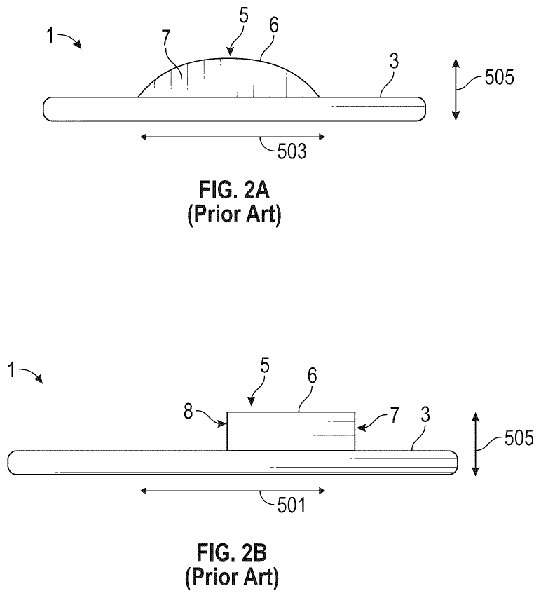

FIG. 1 shows three different embodiments 1A, 1B, 1C of a prior art electrical wiring device 1 comprising a faceplate 3 and a cylindrical occupancy sensor lens 5 that extends outward from the faceplate 3. As can be discerned from viewing FIG. 1 in conjunction with FIGS. 2A and 2B, the occupancy sensor lens 5 is only a partial cylinder due to the sensor lens 5 and the faceplate 3 interfacing, but the sensor lens 5 is referred to as “cylindrical” herein for the sake of brevity. The embodiments of the electrical wiring device 1 are numbered as 1A, 1B, 1C in FIG. 1 in order to denote that the length and width of each occupancy sensor lens 5 differ slightly from one lens 5 to another relative to a length dimension 501 and a width dimension 503, but each embodiment 1A, 1B, 1C can be referred to generally using the reference number 1. In each embodiment of the electrical wiring device 1, the occupancy sensor lens 5 extends out from the faceplate 3 in a depth dimension 505 that is numbered in FIGS. 2A and 2B. The length dimension 501, the width dimension 503, and the depth dimension 505 are all orthogonal to one another.

Each electrical wiring device 1 can be mounted to the wall of a building in order to sense the occupancy of a space and adjust the power provided to a load based on the sensed occupancy. For example and without limitation, the electrical wiring device 1 can be configured to adjust the power provided to a light fixture in a room, such that the device 1 provides more power to the light fixture when the occupancy sensor lens 5 senses at least one person in the room (in order to make the room brighter) and provides less power to the light fixture when the occupancy sensor lens 5 does not sense any people in the room (in order to make the space dimmer). The occupancy sensor lens 5 comprises a plurality of surfaces, including a surface 6, a surface 7, and a surface 8. The wiring device 1 is typically installed in a wall box so that the surface 6 is front-facing, the surface 7 is disposed at the top of the lens 5, and the surface 8 is disposed at the bottom of the lens 5. As such, the surface 6 is referred to hereafter as the “front surface 6”, the surface 7 is referred to hereafter as the “top surface 7”, and the surface 8 is referred to hereafter as the “bottom surface 8”.

FIG. 2A is a top elevation view of one of the electrical wiring devices 1, and FIG. 2B is a side elevation view of the electrical wiring device 1. As shown in FIG. 2A, the occupancy sensor lens 5 being a partial cylinder means that the top surface 7 and the bottom surface 8 are curved (although only the top surface 7 is visible in FIG. 2A), thus causing the occupancy sensor lens 5 to have a curved profile in any viewing plane that extends in the width and depth dimensions 503, 505 and that is orthogonal to the length dimension 501. It will be appreciated that the top surface 7 and bottom surface 8 may be curved but not strictly circular (e.g. may be oval-shaped), but the occupancy sensor lens 5 is still referred to as cylindrical for simplicity. As shown in FIG. 2B, the occupancy sensor lens 5 being cylindrical also causes the occupancy sensor lens 5 to have a rectangular profile in any viewing plane that extends in the length and depth dimensions 501, 505 and that is orthogonal to the width dimension 503.

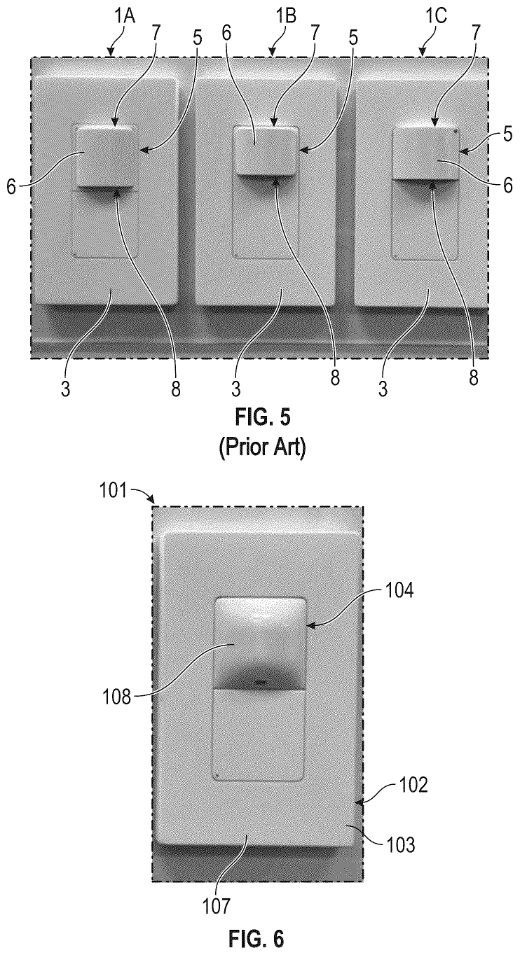

Having a rectangular profile in the viewing plane extending in the length and depth dimensions 501, 505 makes the occupancy sensor lens 5 more prone to accumulating debris, resulting in a perception of reduced hygiene. In addition, under various environmental and lighting conditions, the cylindrical geometry of the occupancy sensor lens 5 leads to abrupt transitions in shape and shadow, which attracts undesirable attention to the wiring device 1. FIG. 5 is a photograph of the existing wiring devices 1A, 1B, 1C that shows the relatively abrupt shadows produced by the cylindrical shape of the occupancy lens 5.

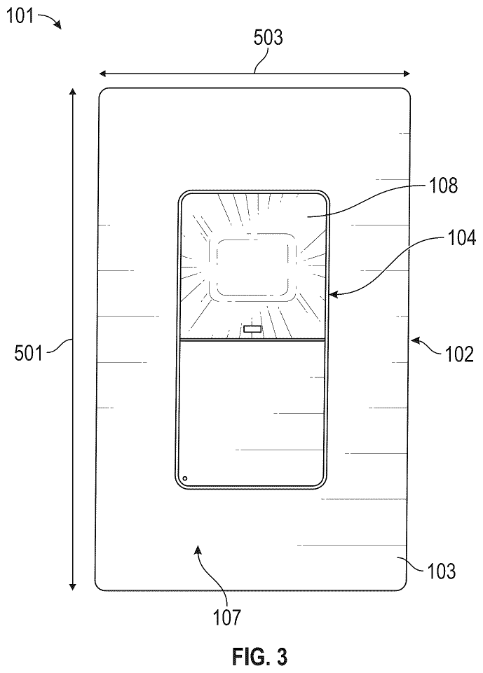

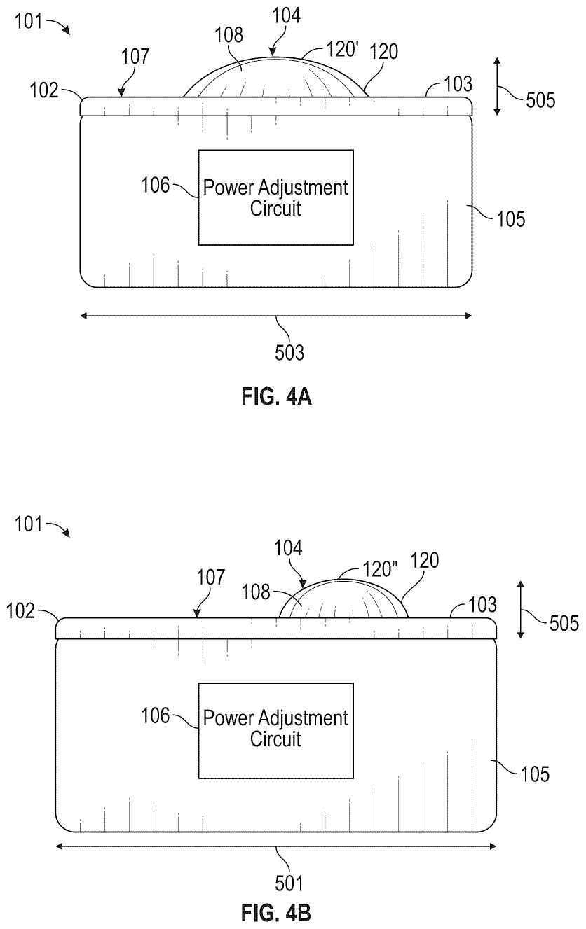

FIG. 3 shows an improved electrical wiring device 101 that includes a front cover 102 comprising a faceplate 103 and an improved dome-shaped occupancy sensor lens 104 that extends out from the faceplate 103, in accordance with an exemplary embodiment of the disclosed concept. The wiring device 101 further comprises a wall box 105 that contains a power adjustment circuit 106, as shown in FIGS. 4A-4B. It is noted that the power adjustment circuit 106 is only depicted in schematic block format in FIGS. 4A-4B. It is further noted that the proportions of the front cover 102 and the wall box 105 are not necessarily drawn to scale in FIGS. 4A-4B, as it is desired to portray certain features of the front cover 102 in a size that sufficiently enables said features to be easily discerned.

The front cover 102 and the wall box 105 are structured to be coupled to one another in order to house the power adjustment circuit 106. The power adjustment circuit 106 and the occupancy sensor lens 104 are in communication with one another, and the power adjustment circuit 106 is configured to adjust the amount of power provided from a power source to a load based on the data obtained by the occupancy sensor lens 104. Similarly to the prior art electrical wiring device 1, the improved electrical wiring device 101 can be mounted to the wall of a building in order to sense the occupancy of a space and adjust the power provided to a load based on the sensed occupancy. The faceplate 103 comprises a front surface 107, which is the surface of the faceplate 103 that is visible when the electrical wiring device 101 is mounted to a wall.

The occupancy sensor lens 104 comprises a single continuous curved surface 108. Aside from where the occupancy sensor lens 104 interfaces with the faceplate 103, the curved surface 108 comprises no edges. This feature of the occupancy sensor lens 104 contrasts the occupancy sensor lens 5, which comprises a first edge where the top surface 7 and the front surface 6 interface and which comprises a second edge where the bottom surface 8 and the front surface 6 interface, in addition to comprising edges where the occupancy sensor lens 5 interfaces with the faceplate 3.

FIG. 4A is a top elevation view of the improved electrical wiring device 101, and FIG. 4B is a side elevation view of the improved electrical wiring device 101. While FIG. 4A and FIG. 4B show two different viewing planes, it is noted that both planes extend in the depth dimension 505 and are perpendicular to the faceplate front surface 107. It is noted that there are an infinite number of planes that extend in the depth dimension 505 and that are perpendicular to the faceplate front surface 107. For each given plane of the infinite number of said planes, the occupancy sensor lens 104 comprises a profile 120 corresponding to that given plane. The profile 120 extends in the depth dimension 505 and at least one of the length dimension 501 or the width dimension 503. FIG. 4A shows the profile 120 in a first plane and FIG. 4B shows the profile 120 in a second plane distinct from the first plane, detailed further hereinafter. The profile 120 in FIG. 4A is also numbered with the reference number 120′ and the profile 120 in FIG. 4B is also numbered with the reference number 120″ in order to denote that the profile 120 lies in a different plane in each figure.

The viewing plane of FIG. 4A is the plane that extends in the width and depth dimensions 503, 505 and is orthogonal to the length dimension 501 and to the faceplate front surface 107. As shown in FIG. 4A, the occupancy sensor lens 104 being dome-shaped causes the first profile 120′ to be curved in the viewing plane of FIG. 4A. The viewing plane of FIG. 4B is the plane that extends in the length and depth dimensions 501, 505 and is orthogonal to the width dimension 503 and to the faceplate front surface 107. As shown in FIG. 4B, the occupancy sensor lens 104 being dome-shaped causes the second profile 120″ to also be curved in the viewing of FIG. 4B. Each of the first and second profiles 120′ and 120″ can, for example and without limitation, form a partial circle or a partial oval.

In addition to the two planes shown in FIG. 4A and FIG. 4B (the one plane being orthogonal to the length dimension 501 and extending only in the width dimension 503 as shown in FIG. 4A, and the other plane being orthogonal to the width dimension 503 and extending only in the length dimension 501 as shown in FIG. 4B), there are an infinite number of planes extending in the depth dimension 505 that extend in both the length dimension 501 and the width dimension 503 and that are orthogonal to the faceplate front surface 107. For example, the wiring device 101 is shown in FIGS. 4A-4B with the wall box 105 at the bottom of the viewing field and with the occupancy sensor lens 104 at the top of the viewing field, and if the wiring device 101 were to be rotated between the position shown in FIG. 4A and the position shown in FIG. 4B while maintaining the wall box 105 at the bottom of the viewing field and maintaining the occupancy sensor lens 104 at the top of the viewing field, the viewing planes in which the wiring device 101 would be visible throughout the rotation would be described as: extending in the depth dimension 505, extending in both the length dimension 501 and the width dimension 503, and being perpendicular to the faceplate front surface 107. Similarly to the first and second profiles 120′ and 120″ shown in FIGS. 4A and 4B, all of the profiles 120 that extend in the depth dimension 505 and that are perpendicular to the faceplate front surface 107 are curved. Each of these profiles can, for example and without limitation, form a partial circle or a partial oval.

The profiles 120 being curved in all planes extending in the depth dimension 505 and orthogonal to the faceplate front surface 107 makes the disclosed occupancy sensor lens 104 significantly less prone to accumulating debris than the prior art occupancy sensor 5, resulting in the occupancy sensor lens 104 appearing significantly cleaner than the prior art occupancy sensor 5. In addition, under various environmental and lighting conditions, the dome-shaped geometry of the disclosed occupancy sensor lens 104 prevents abrupt transitions in shape and shadow, thus causing the wiring device 101 to have a discrete appearance. FIG. 6 is a photograph of the disclosed improved wiring device 101 with dome-shaped occupancy sensor lens 104, and when FIG. 6 is compared to FIG. 5, it can be seen that the dome-shaped wiring device 101 in FIG. 6 produces noticeably less abrupt shadows than the wiring devices 1A, 1B, 1C in FIG. 5 produce. It will be appreciated that the shadows produced by each wiring device 1A, 1B, and 1C in FIG. 5 are specifically produced by the edges formed where the front surface 6 meets the top surface 7 and formed where the front surface 6 meets the bottom surface 8.

While specific embodiments of the invention have been described in detail, it will be appreciated by those skilled in the art that various modifications and alternatives to those details could be developed in light of the overall teachings of the disclosure. Accordingly, the particular arrangements disclosed are meant to be illustrative only and not limiting as to the scope of disclosed concept which is to be given the full breadth of the claims appended and any and all equivalents thereof.

What is claimed is:

1. A front cover for an electrical wiring device, the front cover comprising:
a faceplate with a front surface extending in a width dimension and a length dimension; and
an occupancy sensor lens extending out from the faceplate in a depth dimension,
wherein the width dimension, the length dimension, and the depth dimension are all orthogonal to one another, and
wherein the occupancy sensor lens is dome-shaped such that, in any plane extending in the depth dimension and orthogonal to the front surface, a profile of the occupancy sensor lens is curved relative to the front surface.

2. The front cover of claim 1,
wherein the profile forms a partial circle.

3. The front cover of claim 1,
wherein the profile forms a partial oval.

4. An electrical wiring device, the electrical wiring device comprising:
a wall box;
a power adjustment circuit contained in the wall box; and
a front cover coupled to the wall box, the front cover comprising:
a faceplate with a front surface extending in a width dimension and a length dimension; and
an occupancy sensor lens extending out from the faceplate in a depth dimension,
wherein the width dimension, the length dimension, and the depth dimension are all orthogonal to one another,
wherein the power adjustment circuit and the occupancy sensor lens are in communication with one another,
wherein the power adjustment circuit is configured to adjust the amount of power provided from a power source to a load based on the data obtained by the occupancy sensor lens, and
wherein the occupancy sensor lens is dome-shaped such that, in any plane extending in the depth dimension and orthogonal to the front surface, a profile of the occupancy sensor lens is curved relative to the front surface.

5. The electrical wiring device of claim 4, wherein the profile forms a partial circle.

6. The electrical wiring device of claim 4, wherein the profile forms a partial oval.
